(19) United States
(12) Patent Application Publication
(10) Pub. No.: US 2006/0188322 A1
(43) Pub. Date: Aug. 24, 2006

(54) Dispenser of a cosmetic product, typically of a lipstick

(76) Inventor: Fabrice Dieudonat, Fosses (FR)

Correspondence Address: YOUNG & THOMPSON, 745 SOUTH 23RD STREET, 2ND FLOOR, ARLINGTON, VA, 22202, US

(21) Appl. No.: 11/315,333

(22) Filed: Dec. 23, 2005

(30) Foreign Application Priority Data
Dec. 23, 2004 (FR) 04 13789

(51) Int. Cl. B05C 11/00; B43K 1/06

(52) U.S. Cl. 401/266; 401/265

(57) ABSTRACT

The dispenser (1, 1′) comprising a receptacle (2) forming a cavity (22) that is intended to contain a cosmetic product (7), and a closing cover (3). In this dispenser:

a) the receptacle (2) comprises a body (4) comprising an outside axial wall (40) and an inside axial wall (41), said outside axial walls (40) and inside axial walls (41) forming between themselves an annular axial cavity (43),

b) the receptacle (2) comprises a horizontal wall (5) attached to said inside axial wall (41) and forming a support for said product (7), c) and said receptacle (2) comprises an axial annular skirt forming a collar (6) able to be moved axially in said axial annular cavity (43), typically by a manual effort, such that said collar (6) forms all or part of said lateral axial wall (21) of said cavity (22), said cavity (22) having a variable volume due to a relative axial movement of said collar (6) with respect to said body (4), from a so-called “up” position to a so-called “down” position. Advantages: simplicity of the product-driving mechanism.

### FIELD OF THE INVENTION

The invention relates to the field of dispensers of cosmetic products, especially cosmetic products that are to be applied to the lips, especially lipsticks, whether cosmetic products in solid, semisolid or fluid form.

### PRIOR ART

Conventionally, cosmetic products used as lipsticks form solid products, usually housed in a tube in the form of a stick called a “bullet,” which are applied to the lips in the manner of a brush; this leads to a more or less large amount of lipstick being deposited according to the pressure applied to the tube.

These lipstick tubes comprise a mechanism for manually moving the bullet. This mechanism ordinarily includes, from the inside to the outside, a support of the bullet provided with two radial, diametrically opposite catches, a central tube provided with two axial grooves, and an external concentric tube provided on its inside surface with a helical groove, the two catches crossing the two axial grooves and being guided by the helical grooves, such that rotation relative to the central tube with respect to the external concentric tube drives axial displacement of the support and thus of the bullet.

Dispensers of lipsticks in the form of fluid products are also known. Thus, French Patent No. 2 727 608 describes a dispenser comprising, as the application means, a head with orifices equipped with valves, and as the driving means, an assembly formed by a piston and screw integral with the bottom of the dispenser, the bottom forming a separate piece of the body of the dispenser, such that rotation of the bottom moves the piston toward the head, drives compression of the fluid product and ensures opening of the valves and flow of the product through the orifices of the head.

French Patent No. 2 727 609 is also known in which the driving means includes manual axial movement of a piston due to an axial slot formed in the body of the dispenser.

### PROBLEMS POSED

On the one hand, it is a matter of having simple or inexpensive dispensers to be produced by assembly of component parts at the manufacturer that are easy to fill at the packager of the cosmetic product, and typically lipsticks.

On the other hand, it is also appropriate to have dispensers in which the mechanism of driving the cosmetic product is itself simple in design, inexpensive, and of small volume, relative to the volume of the packaged cosmetic product, so as to have a dispenser with a capacity/height ratio of a rather high level. Actually, application even to the lips dictates a diameter of the dispenser or application means analogous to that of conventional dispensers such that the capacity of the dispenser could not be increased by increasing the diameter of the dispenser.

Moreover, it is advantageous to be able to use the same driving mechanism for producing a great variety of dispensers as much by their ability to package cosmetic products, typically lipsticks, of variable consistency or viscosity, as by their ability to comprise means of application that are suitable for said consistency or viscosity.

Moreover, what matters is that the dispenser is leakproof so that there is no risk of drying of the formulation of the cosmetic product, typically lipstick.

Finally, it is desirable to have dispensers of cosmetic products that offer an appearance that is analogous to that of traditional lipstick tubes in order that the users of traditional dispensers are already familiar with fluid lipstick dispensers.

### DESCRIPTION OF THE INVENTION

According to the invention, the dispenser of a product, typically a cosmetic product, comprises a receptacle that includes a bottom and a lateral axial wall, forming a cavity that is intended to contain said product, and a cover that includes a head and a skirt and that is intended to work with said receptacle for the purpose of closing it when said dispenser is said to be closed.

In this dispenser:

a) said receptacle includes a body comprising an outside axial wall and an inside axial wall, said outside and inside axial walls, of height He and Hi respectively, being made integral with their lower ends forming an annular bottom, in such a way as to form between themselves an annular axial cavity, said cover being able to be temporarily made integral with said outside axial wall, typically on its upper end,

b) said receptacle comprises a horizontal wall forming a support for said product or all or part of said bottom of said cavity, said horizontal wall being made integral with said inside axial wall,

c) said receptacle comprises an axial annular skirt forming a collar of height Hj that works with said body, said collar being able to be moved axially in said axial annular cavity, typically by manual effort, such that said collar forms all or part of said lateral axial wall of said cavity, said cavity having a variable volume due to the relative axial movement of said collar with respect to said body, said cavity having a cavity height Hc, said cavity having a maximum cavity height Hc_{M} when said collar is in the so-called “up” position relative to said body, said receptacle having a maximum height H_{M} and said cavity then being able to contain a maximum amount of said product, and said cavity having a minimum cavity height Hcₘ when said collar is in the so-called “down” position relative to said body, said receptacle having a minimum height Hₘ and said cavity (23) being able to contain a minimum amount of said product.

This dispenser resolves the problems that are posed.

Actually the dispenser according to the invention, at least its simplest embodiment, can comprise only three molded pieces: a cover and a receptacle formed by a body and a movable collar, whereas traditional lipstick dispensers generally include at least four molded pieces; this is a major advantage both in economic and practical terms as much with respect to the manufacture of the molded pieces as with respect to their assembly, which can be a simple axial assembly in the case of this invention.

Moreover, the driving mechanism as such occupies only a relatively small peripheral location.

As will be apparent in the rest of the description below, the dispenser according to the invention is suitable for packaging various cosmetic products of very different consistency or viscosity. It is equally well suited for incorporation of different types of application means, using, moreover, the same driving mechanism.

### DESCRIPTION OF THE FIGURES

All of the figures relate to the invention.

FIGS. 1a to 1g relate to the same dispenser (1, 1′) filled with a cosmetic product in the form of a conventional bullet of lipstick with solid or semisolid consistency.

FIGS. 1a to 1d are side views, and FIGS. 1e to 1g are axial sections.

FIG. 1a shows the dispenser (1, 1′) in the closed state.

FIG. 1b shows the receptacle (2) of the dispenser (1, 1′), obtained after removal of the cover (3), the height of the collar being maximum.

FIG. 1c shows the receptacle (2) with the collar partially driven into the axial annular cavity.

FIG. 1d shows the receptacle (2) with the collar completely driven into the axial annular cavity.

FIG. 1e corresponds to FIG. 1a.

FIG. 1f corresponds to FIG. 1b.

FIG. 1g corresponds to FIG. 1d.

FIGS. 2a to 2f relate to dispensers (1, 1′) of fluid or semifluid cosmetic products. The means of blocking (51) the orifice (50) of the horizontal wall (5) has not been shown in these dispensers (1, 1′).

FIGS. 2a to 2c relate to one embodiment of the dispenser (1, 1′) in which said collar comprises on its upper part an arch (62, 62′) perforated by a plurality of orifices (620) forming an application means.

FIGS. 2d to 2f relate to one embodiment of the dispenser (1, 1′) in which said collar comprises on its upper part an arch (62, 62″) perforated by an orifice (620) forming a support for a separate application means (8).

FIGS. 2a and 2d are analogous to FIG. 1e.

FIGS. 2b and 2e are analogous to FIG. 1f.

FIGS. 2c and 2f are analogous to FIG. 1g.

FIGS. 3a to 3c correspond to the enlarged interior of the broken-line rectangle from FIG. 1f.

FIG. 3a corresponds to FIG. 1f and illustrates a means of axial attaching of the movable collar (6) with the outside axial wall (40) of the body (4).

FIGS. 3b and 3c are variants of dispensers (1) that comprise an annular joint (26) placed between said movable collar (6) [and] the inside axial wall (41) of the body (4).

In FIG. 3b, this annular joint (26) is integral with the inside axial wall (41) at its upper end and on its outside surface.

In FIG. 3c, this annular joint (26) is integral with the movable collar (6) on its lower end and on its inside surface.

FIGS. 4a and 4b are views analogous to FIG. 3a, the upper end of the inside axial wall not having been shown.

FIG. 4a shows a movement of said movable collar by a helical movement, the outside axial wall (40) comprising on its inside surface a helical groove (28) that works with a complementary element (28′) of the movable collar (6), forming a stud.

FIG. 4b illustrates a means of non-reversible movement (64) of the movable collar (6) in the axial annular cavity (43) of the body (4).

FIGS. 4c to 4e are partial axial half-sections of another embodiment of the body (4) according to the invention. In this embodiment, the outside axial walls (40) and inside axial walls (41) are outside axial walls (40′) and inside axial walls (41′) that lock to one another, said inside wall (41′) forming a single-piece part (23) with the horizontal wall (5) that is provided with a central orifice (50).

In this embodiment, the outside axial wall (40) comprises an inside skirt or a plurality of axial inside arms bearing a means for closing (51′) the orifice (50).

FIG. 4c shows the outside axial wall (40′).

FIG. 4d shows the inside axial wall (41′).

FIG. 4e shows the outside axial walls (40′) and inside axial walls (41′) joined by locking, said outside axial wall (40′) being fitted to said inside axial wall (41′) after filling said cavity with product through the orifice (50).

FIGS. 5a and 5b correspond to the enlarged interior of the rectangle in dotted lines from FIG. 2b. In these figures, the arch (62) is an arch (62′) that forms an application means.

In FIG. 5a, said arch (62′) is concave and tilted essentially at 45°.

In FIG. 5b, said arch (62′) is concave and essentially horizontal.

FIGS. 5c to 5d correspond to the enlarged interior of the rectangle in dotted lines of FIG. 2e. In these figures, the arch (62) is an arch (62″) that forms a support for an application material (8).

In FIG. 5c, said arch (62″) and the application material (8) are concave and tilted essentially at 45°.

In FIG. 5d, said arch (62′) and the application material (8) are concave and essentially horizontal.

FIGS. 6a to 6f illustrate other embodiments of dispensers (1).

FIG. 6a, analogous to FIG. 1e, illustrates the case of a dispenser (1) with filling via the top, the dispenser (1) having a solid horizontal wall (5) without an orifice. FIG. 6b that is analogous to FIG. 1g illustrates the case of a dispenser (1) with filling via the bottom, the dispenser (1) having a horizontal wall (5) provided with an orifice (50), closed by a closing means (51) in the form of a plug.

FIG. 6c, analogous to FIG. 1g and FIG. 6a, illustrates the case of a dispenser (1) in which the space of the lower cavity (46) is occupied by a stationary auxiliary applicator (9), provided with a grasping means (90) and an auxiliary application material (91).

FIG. 6d, analogous to FIG. 2a, illustrates the case of a dispenser (1) in which the space of the lower cavity (46) forms an auxiliary reservoir for said product, closed by a closing means (47) composed of a plug forming an axially movable piston so as to be able to transfer the product contained in said auxiliary reservoir into the cavity (22) forming the main reservoir for said product.

FIGS. 6e, 6f, and 7a to 8b are axial sections that illustrate the case of a lipstick dispenser (1) in which said horizontal wall (5) that is provided with an orifice (50) in the case of bottom filling is a movable wall (5′) that is able to slide in said inside axial wall (41) from an initial “down” position to a final “up” position so as to be able to make said product in reserve rise again above the upper edge of said inside axial wall (41) and to make it accessible.

In FIG. 6e, analogous to FIG. 6a, the movable wall (5′) is in the “down” position, and the bullet of lipstick occupies the cavity (22′) that extends over the entire height of said dispenser.

In FIG. 6f, the movable wall (5′) has been raised into the “up” position, a portion of the lipstick having been used up beforehand.

FIG. 7a shows the movable wall (5′) provided with an orifice (50).

FIG. 7b shows the movable wall (5′) provided with an orifice (50) closed by a closing means (51) in the form of a plug.

FIG. 7c is a partial view of the body (4) that represents the lower portion of the body (4) with the lower portions of the outside axial walls (40) and inside axial walls (41), these walls being joined at their base to form an annular bottom (42).

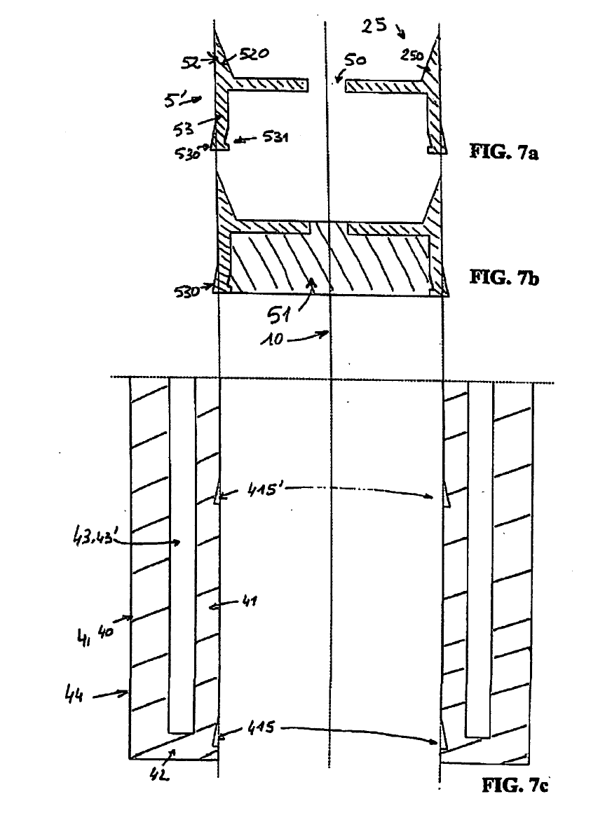

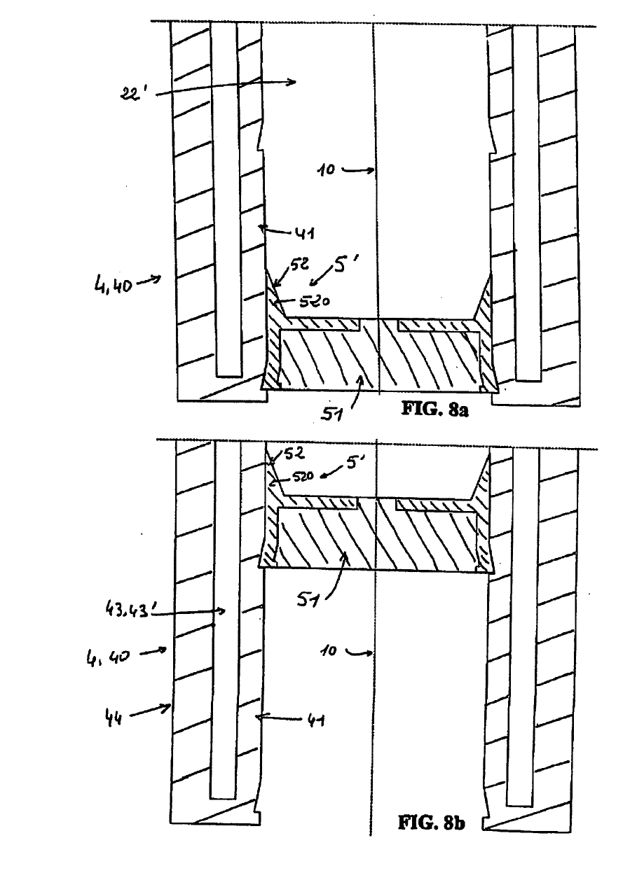

The inside axial wall (41) comprises a bottom (415) and top radial annular notch (415′) such that FIGS. 8a and 8b, analogous to FIGS. 7b and 7c, are partial views of the receptacle (2) that represent the lower portion of the body (4) from FIG. 7c, provided with the movable wall (5′) from FIG. 7b.

In FIG. 8a, the mobile wall (5′) is in the initial “down” position, whereas in FIG. 8b, the movable wall (5′) is in the final “up” position.

### DETAILED DESCRIPTION OF THE INVENTION

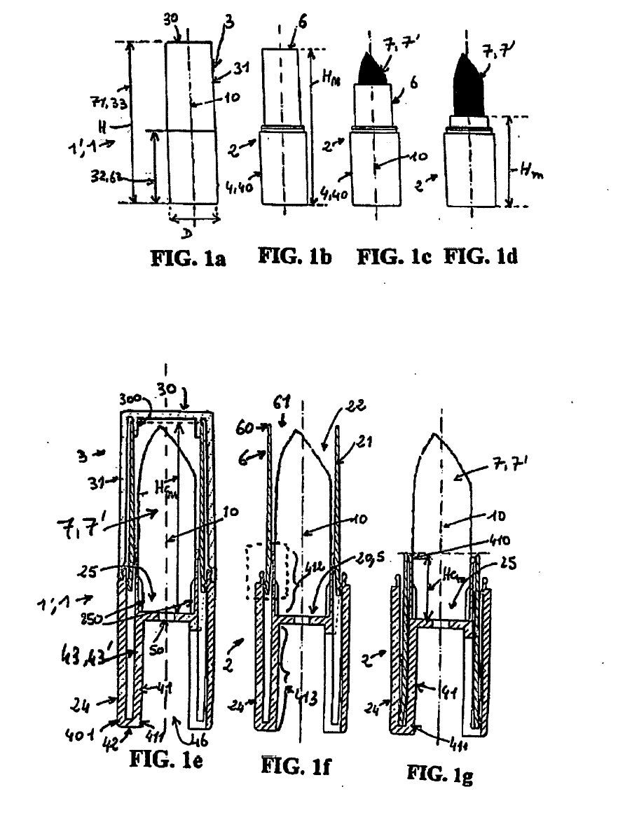

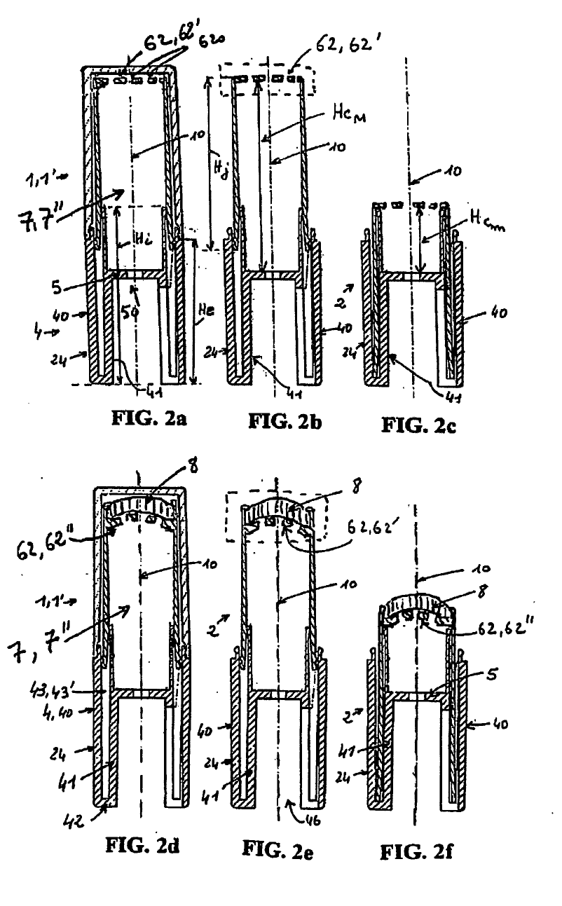

As illustrated in, for example, FIGS. 1e to 2f, said outside axial walls (40) and inside axial walls (41) can form a single-piece molded part (44) that is made of plastic.

However, according to another embodiment, said horizontal wall (5) and said inside axial wall (41) can form a single-piece molded part (23, 24) that is made of plastic.

According to another embodiment, said horizontal wall (5) is a horizontal wall (5′) forming a separate portion of said inside axial wall (41) and is able to slide within said inside axial wall (41).

As illustrated in FIGS. 1a to 2f, said horizontal wall (5), said inside axial wall (41) and said outside axial wall (40) can form a single-piece molded part (24) that is made of plastic.

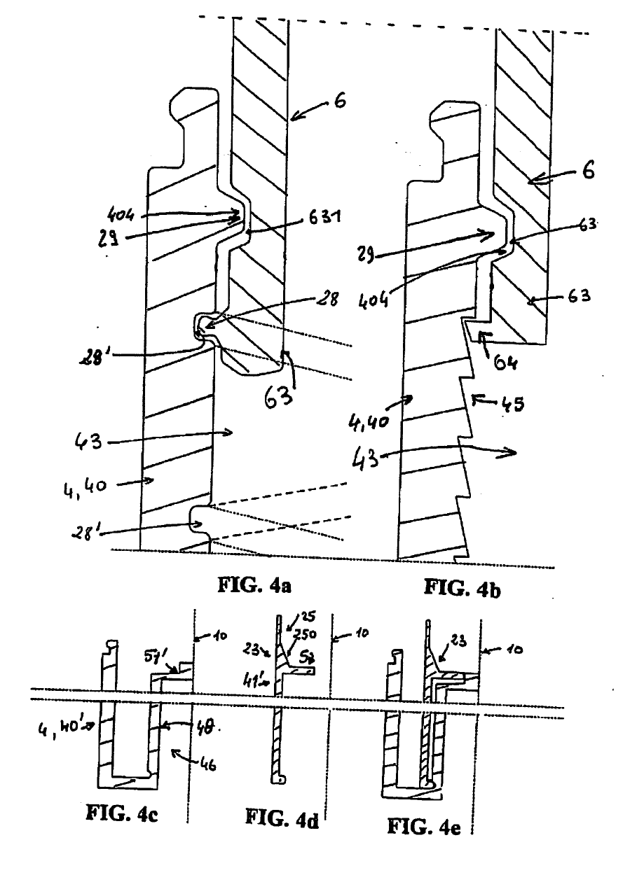

As illustrated in FIGS. 4c to 4e, however, said horizontal wall (5) and said inside axial wall (41′) can form a single-piece molded part (23), said outside axial wall (40) being a wall (40′) that can be locked to said inside axial wall (41′).

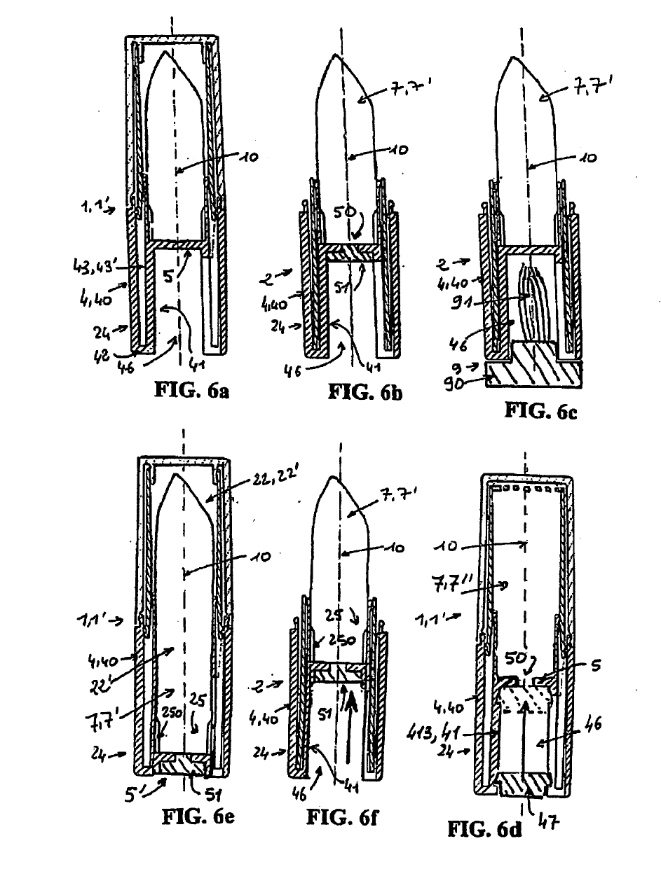

Typically, and as illustrated in many figures except for FIGS. 6a and 6c, said horizontal wall (5, 5′) can comprise an orifice (50) so as to allow filling via the bottom of said dispenser (1), and a means of closing (51, 51′) said orifice (50).

According to the invention, and as illustrated in, for example, FIGS. 1a to 1g, said collar (6) can have an upper end (60) that forms an upper orifice (61) for said cavity (22), said product (7) being in this case a solid or semisolid product (7′), typically in the form of a bullet of lipstick, or a deodorant stick, or a soap.

In the case in which said product (7) is a solid or semisolid product (7′), said horizontal wall (5, 5′) can be joined, usually at a right angle, to said inside axial wall (41) of height Hi so as to divide said inside axial wall (41) into an upper inside wall (412) of height Hi_{H} ranging typically from 3 mm to 15 mm, and a lower inside wall (413) of height Hi_{B} ranging typically from 20 mm to 50 mm, with Hi=Hi_{H}+Hi_{B} and so that said upper inside wall (412) and said horizontal wall (5) form an anchor tray (25) of said solid or semisolid product (7′), said tray (25) comprising typically on its inside axial wall a plurality of axial flanges (250) for attaching said product.

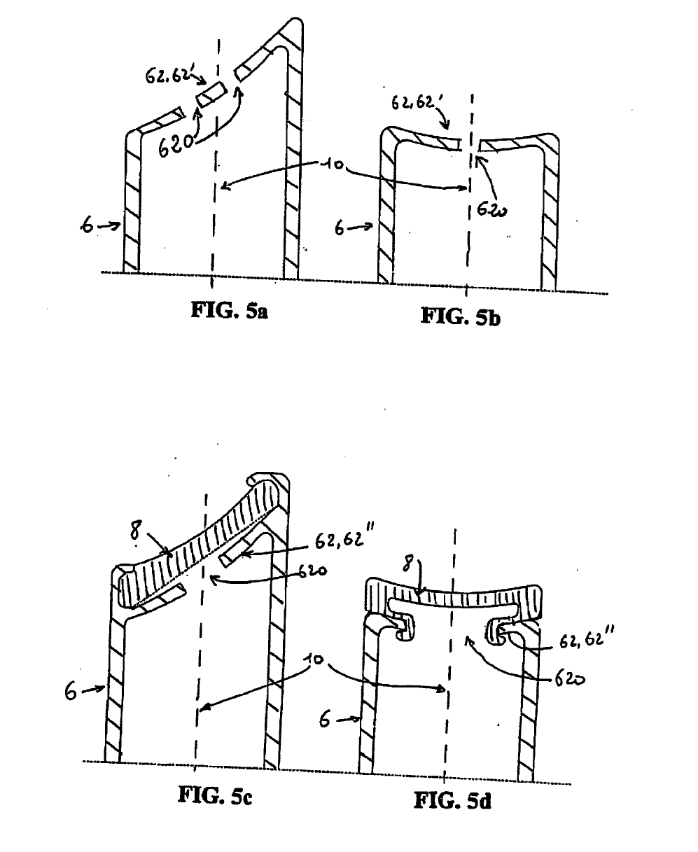

As illustrated in, for example, FIGS. 2a to 2f and 5a to 5d, said collar (6) can be integral, on its upper end (60), with an arch (62) that is provided with at least one orifice (620), said arch (62) being flat or concave or convex, said product (7) being in this case a fluid product (7″), typically a cream that is able to flow through said orifice (620), especially when a manual axial movement of said collar (6) in said axial annular cavity (43) reduces said variable volume of said cavity (23).

As illustrated in, for example, FIGS. 2a to 2c, 5a and 5b, said arch (62) can be an arch (62′) that forms a means or material of application (8) of said fluid product (7″). As illustrated in FIGS. 2d to 2f, 5c and 5d, said arch (62) can be an arch (62″) that is made integral with an application means or material (8′) for said fluid product (7″), said arch (62) then forming a support for said application means or material (8′), said application means or material (8′) covering all or part of said arch (62), said application means or material being able to be saturated with said fluid product (7″) due to a flow of said product through said orifice (620).

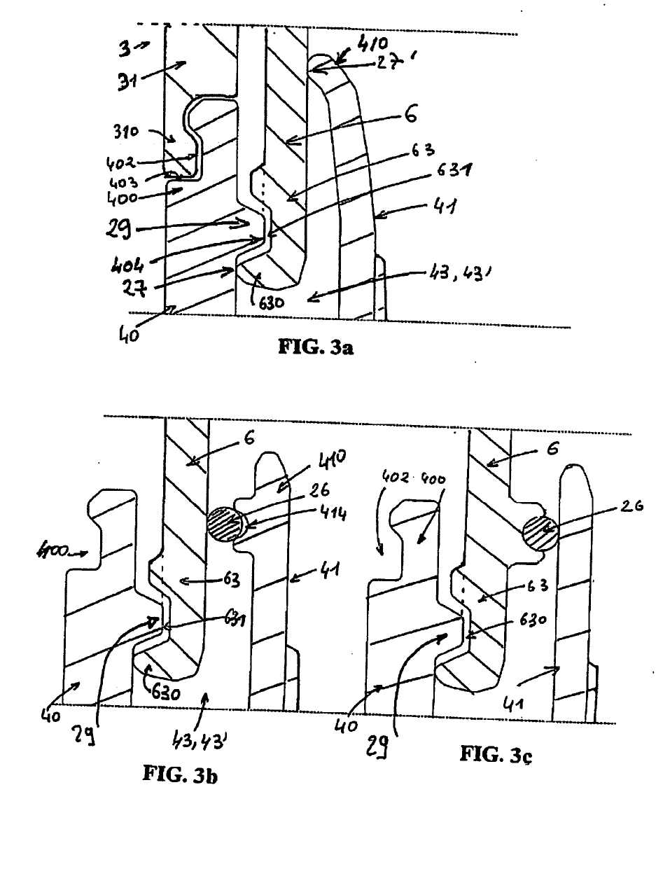

In the case in which said product (7) is a fluid product (7″), it is advantageous that said collar (6) and said inside axial wall (41) or said horizontal wall (5) can work together in a leakproof manner, possibly due to an annular gasket (26), such that said fluid product (7″) cannot flow into said axial annular cavity (43), as has been illustrated in FIGS. 3b and 3c.

As illustrated in, for example, FIGS. 1a to 2f, said axial annular cavity (43) can be a straight cavity without any obstacle (43′) such that said axial movement can correspond to a relative axial translatory motion of said collar (6) with respect to said body (4), said axial translatory motion being obtained typically by applying a relative axial manual pressure to said collar (6) with respect to said body (4).

Advantageously, said collar (6) and said body (4) can work with at least one friction zone (27, 27′), typically at least one annular friction zone with a contact of “cone-plane” or “torus-cylinder” type, with a level of friction that is selected such that any relative axial movement of said collar (6) is only the result of said manual effort, and in such a manner as to form a leakproof receptacle (2).

As illustrated in FIG. 3a, said collar (6) and said body (4) can work with two friction zones: one lower friction zone (27) formed by contact between the inside of said outside axial wall (40) and a radial rib (630) formed on the outside of said collar (6) on its lower end (63), an upper friction zone (27′) formed by the contact between the inside of said collar (6) and a radial rib (414) formed on the outside of said inside axial wall (41), typically on its upper end (410).

According to another embodiment of the invention, as illustrated in FIG. 4a, said collar (6) and said body (4) can work with a rib or a helical groove (28) borne by said collar (6) or said body (4), and a complementary element (28′) borne by said body (4) or said collar (6) respectively, such that relative manual rotation of said collar (6) with respect to said body (4) drives said axial movement of said collar (6) relative to said body (4).

As illustrated especially in FIGS. 3a to 4b, said collar (6) and said body (4) can comprise means of axial attachment (29), typically axial locking, so as to prevent said collar (6) from being involuntarily separated from said body (4).

As illustrated in FIG. 4b, said collar (6) and said body (4) work by means of non-reversible movement, some (64) borne by said collar (6) and others (45), opposite, borne by said body, said means (64, 45) forming teeth or male and female elements opposite, with angles oriented so as to allow said axial movement that comprises progressively forcing said skirt collar (6) into said axial annular cavity (43) as said product (7, 7′, 7″) is used up, while preventing reverse axial movement that would lead to an increase of said height of the cavity Hc.

As illustrated in FIG. 3a, said outside axial wall (40) towards its upper end (400) has a hollowed annular portion (402) that forms a shoulder (403) that is able to work with a lower end (310) of the skirt (31) of said cover (3), such that when said dispenser (1) is closed, said cover (3) and said outside axial wall (40) exhibit surface continuity and typically the same outside section.

According to the invention, said outside axial wall (40), said collar (6) and said inside axial wall (41) can have homothetic transverse sections of any shape, typically circular or round, oval, square, triangular or rectangular.

The dispensers (1) according to the invention can have a form factor H/D ranging from 2 to 6, H being the height of said closed dispenser (1), and D being the diameter or the largest transverse dimension, D being the average diameter or the greatest average dimension when said dispenser (1) has a transverse section that is variable over its height, so as to have a longitudinal dispenser (1′) with an axial direction (10) typically forming an axis of symmetry.

In these dispensers (1), H can range from 40 mm to 120 mm, preferably 60 mm to 100 mm.

In these dispensers (1), the ratio H_{M}/Hₘ can be chosen to be relatively near 2, said ratio ranging typically from 1.6 to 1.9, so that, on the one hand and all things otherwise being equal, said dispenser (1) offers an increased storage capacity for this product, ranging typically from 1.5 to 8 ml, said storage capacity corresponding to said maximum volume V_{M}, and on the other hand, said collar (6) and said body (4) work together over a height h sufficient for said collar (5) and said body (4) to be attached even when said receptacle (2) has said maximum height H_{M}.

This ratio Hcₘ/Hc_{M} can be less than 0.35 and preferably less than 0.1 such that the fraction of said product remaining in said dispenser when said collar (6) is in the so-called “down” position relative to said body (4) is the smallest possible and preferably less than 10% of the initial amount of the product (7) when said collar (6) is in the so-called “up” position relative to said body (4).

As illustrated in, for example, FIG. 1e, said head (30) of said cover (3) can comprise an inside sealing skirt (300) intended to work with said collar (6) on its upper end (60), typically before first opening of said dispenser (1) so as to ensure the sealing of said dispenser (1, 1′).

As illustrated in FIGS. 6c and 6d, said inside axial wall (41) and said horizontal wall (5) can delineate a lower cavity (46) able to accommodate a means of application of said product in a typically stationary manner, or another product, said other product possibly comprising a reserve of said product, due to a lower plug (47) able to be used to close said lower cavity (46) on its lower portion, and possibly as a piston able to make said other product pass into said cavity (23) through said orifice (50).

As illustrated in FIG. 16e, said horizontal wall (5) can be a movable wall (5′) able to slide in said inside axial wall (41) from an initial “down” position to a final “up” position so as to be able to make said reserve product rise above the upper edge of said inside axial wall (41) and to make it accessible. FIG. 6e shows a dispenser (1) of solid or semisolid product (7, 7′); said collar has an upper end (60) forming an upper orifice (61) as in the case of FIGS. 1a to 1g. However, this embodiment also applies to the case in which, as illustrated in FIGS. 2a to 2f, said collar (6) is integral, on its upper end (60), with an arch (62) that is provided with at least one orifice (620), said arch (62) being flat or concave or convex, said product (7) then being a fluid product (7″), typically a cream, able to flow through said orifice (620).

### Embodiments

The figures comprise embodiments.

A longitudinal lipstick dispenser (1, 1′) according to FIGS. 1a to 1g was produced.

This dispenser (1) with a diameter D of 21.04 mm and a height H equal to 71.33 mm has a form factor H/D equal to 3.4.

To produce this dispenser (1), first its various component parts are molded of plastic:

the receptacle (2) forming a single-piece molded part (24) composed of outside axial walls (40) and inside axial walls (41) and a horizontal wall (5) that is provided with a filling orifice (50),

the annular collar (6),

and the cover (3).

Then, the annular collar (6) is joined to the receptacle (2) by locking. The bullet (7′) of lipstick was formed separately and placed in the anchor tray (25) that is provided with radial and axial flanges (250).

According to another embodiment that is not shown in FIGS. 1a to 1g, the cover (3) can comprise an inside form or an inside insert allowing the dispenser (1) to be filled through the bottom, i.e., through the orifice (50) and a molded bullet (7′) with an upper end as shown in FIGS. 1c, 1e and 1f to be obtained.

A longitudinal dispenser (1, 1′) of a fluid cosmetic product according to FIGS. 2a to 2c was produced. This dispenser (1, 1′) differs from the one of FIGS. 1a to 1g in which said annular skirt (6) comprises an arch (62) that includes a plurality of orifices (620) and directly forms a means of application (62′).

A longitudinal dispenser (1, 1′) of a fluid cosmetic product (7, 7″) according to FIGS. 2d to 2f was produced. This dispenser (1, 1′) differs from the one of FIGS. 2a to 2c in that said annular skirt (6) comprises an arch (62) that includes a plurality of orifices (620) and forms a support (62″) of a means of application (8) composed of an alveolar or fibrous mass allowing passage of said product and its regular application, typically to the lips or the face.

In the dispensers (1, 1′) according to FIGS. 1a to 2f, the annular skirt (6) comprises on its lower end (63) an outside radial groove (631) that works with the inside radial rib (404) borne by said outside axial wall (40) on its upper end (400) so as to form a means of axial attachment (29). This means (29) makes it possible to have a dispenser (1) with a cavity (22) of maximum height Hc_{M}; however, an axial manual effort, during application of said product by the user, allows the annular skirt (6) to be made to slide in the axial annular cavity (43) formed between the outside axial walls (40) and inside axial walls (41).

The sealing of the dispenser (1, 1′) has been formed by two friction zones (27, 27′) with contact of the “O-ring/cylinder” type as illustrated in FIG. 3a:

a first friction zone (27) has been formed by contact of the lower end (63) of the annular skirt (6), forming an outside radial rib (630) on the inside wall of said outside axial wall (40),

a second friction zone (27′) has been formed by the contact of the upper end (410) of said inside axial wall (41) against the inside surface of said annular skirt (6).

Sealing of the dispensers (1) has likewise been accomplished according to the embodiments illustrated in FIGS. 3b and 3c.

In this case, an O-ring (26) was used. This ring (26) can be integral with the inside axial wall (41) due to an annular groove (414) as illustrated in FIG. 3b, integral with said annular skirt (6), as illustrated in FIG. 3c.

The dispensers (1, 1′) of FIGS. 1a to 2f have likewise been produced according to other embodiments.

Thus, according to the embodiment of FIG. 4a, the outside axial wall (40) comprises on its inside surface at least one helical groove (28′) that works with an outside rib (28) borne by the annular skirt (6) on its lower end (63) such that a rotation of the skirt (6) drives its axial movement toward the bottom, in order to reduce the height Hc of said cavity (22).

According to the embodiment of FIG. 4b, the outside axial wall (40) includes a plurality of circular notches (45) working with a radial projection (64) so as to form a means of non-reversible movement, the annular skirt (6) only being able to be recessed into the axial annular cavity (43).

According to the embodiment of FIGS. 4c to 4e, said body (4) can be formed from two parts:

one part comprising the outside axial wall (40, 40′), an inside axial projection (48) integral with a closing means (51′),

and a part comprising the inside axial wall (41, 41′) and the horizontal wall (5), these two pieces being lockable as shown in FIG. 4e.

FIGS. 5a and 5b correspond to other embodiments of the dispenser (1, 1′) according to FIGS. 2a to 2c, whereas FIGS. 5c and 5d correspond to other embodiments of the dispensers (1, 1′) according to FIGS. 2d to 2f.

The dispensers (1, 1′) according to FIGS. 1a to 1g have likewise been produced according to FIG. 6a in which said horizontal wall (5) has no orifice (50). In this case, the lipstick bullet (7, 7′) can be molded separately and introduced through the upper orifice (61) as well as according to FIG. 6b, in which the orifice (50) of the horizontal portion (5) of the dispensers (1, 1′) according to FIGS. 1a to 1g can be closed by a plug (51).

The dispensers (1, 1′) according to FIGS. 1a to 2f comprise a lower cavity (46) that can either remain unused, or be advantageously used as illustrated in FIGS. 6c to 8b.

In FIG. 6c, the lower cavity (46) is used to accommodate an auxiliary applicator (9).

In FIG. 6d, the applicator (1, 1′) is analogous to that of FIGS. 2a to 2c, and the lower cavity (46) forms a fluid product reserve (7, 7′), this cavity (46) being closed by a closing means (7) that forms a piston that is able to slide within the lower inside wall (413) of the inside axial wall (41) from a “down” position as shown by the solid line in FIG. 6d, up to an “up” position as shown by the dotted lines in FIG. 6d, abutting against the horizontal wall (5).

In FIGS. 6f to 8b, the horizontal wall (5) is a movable wall (5′) that can slide, as in the case of the dispenser according to FIG. 6d, from a “down” position as shown in FIG. 6e, up to an “up” position as shown in FIG. 6f.

Said movable wall (5′) was shown in FIG. 7a, just like in FIG. 7b, with a closing means (51), while the lower portion of the body (4) was shown in FIG. 7c.

The inside axial wall (41) of the body (4) comprises two radial blocking notches, a lower notch (415) and an upper notch (415′), these notches being intended to work with a radial projection (530) borne by the lower skirt (53) of the movable wall (5′) in such a way that the movable wall (5′) can pass from one lower position shown in FIG. 8a, and corresponding to FIG. 6e, to an upper position shown in FIG. 8b, and corresponding to FIG. 6f, and that thus the reserve bullet, stored in a volume corresponding essentially to that of said lower cavity (46), can be used.

### ADVANTAGES OF THE INVENTION

The invention has many advantages.

On the one hand, it makes it possible to produce dispensers (1, 1′) that are simple and inexpensive to produce, especially because these dispensers can include a mechanism for driving the cosmetic product, itself simple in design and inexpensive.

On the one hand, these dispensers are suitable for different types of cosmetic products, and especially lipsticks that can vary in their consistency or their viscosity. Thus, the entire range of the product from the traditional solid bullet to fluid lipstick can be packaged in dispensers (1, 1′) according to the invention.

Moreover, the dispensers (1, 1′) can have an increased storage capacity for the cosmetic product, and even greatly increased in the case of the embodiments of the dispensers of FIGS. 6d to 6e.

Finally, the dispensers (1, 1′) according to the invention include different means allowing them to be sealed and are thus able to package cosmetic products including a volatile component.

LIST OF REFERENCES

| | |
|---|---|
| Dispenser | 1 |
| Longitudinal dispenser | 1′ |
| Axial direction | 10 |
| Receptacle | 2 |
| Bottom | 20 |
| Lateral axial wall | 21 |
| Cavity | 22 |
| Cavity with movable wall 5′ | 22′ |
| Single-piece molded part 41′ + 5 | 23 |
| Single-piece molded part 40 + 41 + 5 | 24 |
| Anchor tray of 7 | 25 |
| Axial and radial attachment flanges of 7′. | 250 |
| Annular joint between 6 and 40 or 41 | 26 |
| Friction zone between 4 and 6 | 27, 27′ |
| Helical rib or groove of 4 or 6 | 28 |
| Complementary element of 6 or 4 | 28′ |
| Means of axial attachment of 4 and 6 | 29 |
| Cover | 3 |
| Head | 30 |
| Inside sealing skirt | 300 |
| Skirt | 31 |
| Lower end | 310 |
| Body | 4 |
| Outside axial wall | 40, 40′ |
| Upper end | 400 |
| Lower end | 401 |
| Hollowed part | 402 |
| Shoulder | 403 |
| Inside radial rib | 404 |
| Inside axial wall | 41, 41′ |
| Upper end | 410 |
| Lower end | 411 |
| Upper inside wall | 412 |
| Lower inside wall | 413 |
| External radial groove of 41 for 26. | 414 |
| Radial blocking notches of 5′ | 415, 415′ |
| Annular bottom | 42 |
| Axial annular cavity | 43 |
| Straight cavity | 43′ |
| Single-piece molded part 40 + 41 | 44 |
| Means of non-reversible movement | 45 |
| Lower cavity | 46 |
| Closing means of 46 | 47 |
| Inside axial projection | 48 |
| Horizontal wall - support of 7 | 5 |
| Movable horizontal wall | 5′ |
| Orifice | 50 |
| Closing means of 50 | 51, 51′ |
| Top edge of 5′ | 52 |
| Radial attaching flanges of 7′ | 520 |
| Lower skirt of 5′ | 53 |
| Annular outside radial projection | 530 |
| Annular inside notch | 531 |
| Axial annular skirt - collar | 6 |
| Upper end | 60 |
| Upper orifice of 6 and of 22 | 61 |
| Arch | 62 |
| Arch forming an application means | 62′ |
| Arch bearing an application means | 62″ |
| Orifice | 620 |
| Lower end | 63 |
| Outside radial rib | 630 |
| Outside radial groove | 631 |
| Means of non-reversible movement | 64 |
| Product | 7 |
| Solid or semisolid product | 7′ |
| Fluid product | 7″ |
| Application material or means | 8 |
| Auxiliary applicator | 9 |
| Grasping means | 90 |
| Auxiliary application material | 91 |

1. Dispenser (1, 1′) of a product (7), typically a cosmetic product, comprising a receptacle (2) that includes a bottom (20) and a lateral axial wall (21), forming a cavity (22) that is intended to contain said product (7), and a cover (3) that includes a head (30) and a skirt (31) and that is intended to work with said receptacle (2) for the purpose of closing it when said dispenser (1) is said to be closed, in which:
a) said receptacle (2) includes a body (4) comprising an outside axial wall (40) and an inside axial wall (41), said outside axial walls (40) and inside axial walls (41), of height He and Hi respectively, being attached by their bottom ends (401, 411) forming an annular bottom (42), in such a way as to form between themselves an annular axial cavity (43), said cover (3) being able to be temporarily attached to said outside axial wall (40), typically on its upper end (400),
b) said receptacle (2) comprises a horizontal wall (5) forming a support for said product or all or part of said bottom (20) of said cavity (22), said horizontal wall (5) being attached to said inside axial wall (41),
c) said receptacle (2) comprises an axial annular skirt forming a collar (6) of height Hj that works with said body (4), said collar (6) being able to be moved axially in said axial annular cavity (43), typically by manual effort, so that said collar (6) forms all or part of said lateral axial wall (21) of said cavity (22), said cavity (22) having a variable volume due to the relative axial movement of said collar (6) with respect to said body (4), said cavity (22) having a cavity height Hc, said cavity having a maximum cavity height Hc_{M} when said collar (6) is in the so-called “up” position relative to said body (4), said receptacle (2) having a maximum height H_{M} and said cavity (22) then being able to contain a maximum amount of said product (7), and said cavity (22) having a minimum cavity height Hcₘ when said collar (6) is in the so-called “down” position relative to said body (4), said receptacle (2) having a minimum height Hₘ and said cavity (22) being able to contain a minimum amount of said product (7).

2. Dispenser according to claim 1, in which said outside axial walls (40) and inside axial walls (41) form a single-piece molded part (44) that is made of plastic.

3. Dispenser according to claim 1, in which said horizontal wall (5) and said inside axial wall (41) form a single-piece molded part (23, 24) that is made of plastic.

4. Dispenser according to claim 1, in which said horizontal wall (5) comprises an orifice (50) in order to allow filling via the bottom of said dispenser (1), and a means for closing (51, 51′) said orifice (50).

5. Dispenser according to claim 1, in which said collar (6) has an upper end (60) that forms an upper orifice (61) for said cavity (22), and in which said product (7) is a solid or semisolid product (7′), typically in the form of a bullet of lipstick, or a deodorant stick, or soap.

6. Dispenser according to claim 5, in which said horizontal wall (5) is joined, usually at a right angle, to said inside axial wall (41) of height Hi so as to divide said inside axial wall (41) into an upper inside wall (412) of height Hi_{H} ranging typically from 3 mm to 15 mm, and a lower inside wall (413) of height Hi_{B} ranging typically from 20 mm to 50 mm, with Hi=Hi_{H}+Hi_{B} and such that said upper inside wall (412) and said horizontal wall (5) form an anchor tray (25) of said solid or semisolid product (7′), said tray (25) comprising typically on its inside axial wall a plurality of axial flanges (250) for attaching said product.

7. Dispenser according to claim 1, in which said collar (6) is integral, on its upper end (60), with an arch (62) that is provided with at convex, and in which said product (7) is a fluid product (7″), typically a cream that is able to flow through said orifice (620), especially when a manual axial movement of said collar (6) in said axial annular cavity (43) reduces said variable volume of said cavity (23).

8. Dispenser according to claim 7, in which said arch (62) is an arch (62′) that forms a means or material of application (8) of said fluid product (7″).

9. Dispenser according to claim 7, in which said arch (62) is an arch (62″) attached to an application means or material (8′) for said fluid product (7″), said arch (62) then forming a support for said application means or material (8′), said application means or material (8′) covering all or part of said arch (62), said application means or material being able to be saturated with said fluid product (7″) due to a flow of said product through said orifice (620).

10. Dispenser according to claim 7, in which said collar (6) and said inside axial wall (41) or said horizontal wall (5) work together in a leakproof manner, possibly due to an annular joint (26), such that said fluid product (7″) cannot flow into said axial annular cavity (43).

11. Dispenser according to claim 1, in which said axial annular cavity (43) is a straight cavity without any obstacle (43′) such that said axial movement can correspond to a relative axial translatory motion of said collar (6) with respect to said body (4), said axial translatory motion being obtained typically by applying relative axial manual pressure to said collar (6) with respect to said body (4).

12. Dispenser according to claim 11, in which said collar (6) and said body (4) work with at least one friction zone (27, 27′), typically at least one annular friction zone with a contact of “cone-plane” or “torus-cylinder” type, with a level of friction that is selected such that any relative axial movement of said collar (6) is only the result of said manual effort, and in such a manner as to form a leakproof receptacle (2).

13. Dispenser according to claim 12, in which said collar (6) and said body (4) work with two friction zones: one lower friction zone (27) formed by contact between the inside of said outside axial wall (40) and a radial rib (630) formed on the outside of said collar (6) on its lower end (63), an upper friction zone (27′) formed by the contact between the inside of said collar (6) and a radial rib (414) formed on the outside of said inside axial wall (41), typically on its upper end (410).

14. Dispenser according to claim 1, in which said collar (6) and said body (4) work with a rib or a helical groove (28) borne by said collar (6) or said body (4), and a complementary element (28′) borne respectively by said body (4) or said collar (6), such that relative manual rotation of said collar (6) with respect to said body (4) drives said axial movement of said collar (6) relative to said body (4).

15. Dispenser according to claim 1, in which said collar (6) and said body (4) comprise means of axial attachment (29), typically axial locking, so as to prevent said collar (6) from being involuntarily separated from said body (4).

16. Dispenser according to claim 1, in which said collar (6) and said body (4) work together by means of non-reversible movement, some (64) borne by said collar (6) and others (45), opposite, borne by said body, said means (64, 45) forming teeth or male and female elements opposite, with angles oriented so as to allow said axial movement that comprises progressively recessing said skirt collar (6) into said axial annular cavity (43) as said product (7, 7′, 7″) is used up, while preventing a reverse axial movement that would lead to an increase of said height of the cavity Hc.

17. Dispenser according to claim 1, in which said outside axial wall (40) towards its upper end (400) has a hollowed annular part (402) that forms a shoulder (403) that is able to work with the lower end (310) of the skirt (31) of said cover (3), such that when said dispenser (1) is closed, said cover (3) and said outside axial wall (40) exhibit surface continuity and typically the same outside section.

18. Dispenser according to claim 1, in which said outside axial wall (40), said collar (6) and said inside axial wall (41) have homothetic transverse sections of any shape, typically circular or round, oval, square, triangular or rectangular.

19. Dispenser according to claim 1 with a form factor H/D ranging from 2 to 6, H being the height of said closed dispenser (1), and D being the diameter or the largest transverse dimension, D being the average diameter or the greatest average dimension when said dispenser (1) has a transverse section that is variable over its height, so as to have a longitudinal dispenser (1′) with an axial direction (10) typically forming an axis of symmetry.

20. Dispenser according to claim 19, in which H ranges from 40 mm to 120 mm, and preferably from 60 mm to 100 mm.

21. Dispenser according to claim 1, in which the ratio H_{M}/Hₘ is chosen to be relatively near 2, said ratio ranging typically from 1.6 to 1.9, such that, on the one hand and all things otherwise being equal, said dispenser (1) offers an increased storage capacity for this product, ranging typically from 1.5 to 8 ml, said storage capacity corresponding to said maximum volume V_{M}, and that, on the other hand, said collar (6) and said body (4) work over a height h sufficient for said collar (5) and said body (4) to be attached even when said receptacle (2) has said maximum height H_{M}.

22. Dispenser according to claim 1, in which the ratio Hcₘ/Hc_{M} is less than 0.35 and preferably less than 0.1, such that the fraction of said product remaining in said dispenser when said collar (6) is in the so-called “down” position relative to said body (4) is the smallest possible and preferably less than 10% of the initial amount of the product (7) when said collar (6) is in the so-called “up” position relative to said body (4).

23. Dispenser according to claim 1, in which said head (30) of said cover (3) comprises an inside sealing skirt (300) intended to work with said collar (6) on its upper end (60), typically before a first opening of said dispenser (1), so as to ensure the sealing of said dispenser (1, 1′).

24. Dispenser according to claim 1, in which said inside axial wall (41) and said horizontal wall (5) delineate a lower cavity (46) able to accommodate a means of application of said product, typically in a stationary manner, or another product, said other product possibly comprising a reserve of said product, due to a lower plug (47) able to be used to close said lower cavity (46) on its lower part, and possibly as a piston able to make said other product pass into said cavity (23) through said orifice (50).

25. Dispenser according to claim 1, in which said horizontal wall (5) is a movable wall (5′) able to slide in said inside axial wall (41) from an initial “down” position to a final “up” position so as to be able to make said reserve product rise above the upper edge of said inside axial wall (41) and to make it accessible.
